(19) United States
(12) Patent Application Publication
(10) Pub. No.: US 2022/0186860 A1
(43) Pub. Date: Jun. 16, 2022

(54) JOINT

(71) Applicant: FUMOTO GIKEN CO., LTD., Miura-gun (JP)

(72) Inventor: Ryohei YAMAMOTO, Miura-gun (JP)

(73) Assignee: FUMOTO GIKEN CO., LTD., Miura-gun (JP)

(21) Appl. No.: 17/386,155

(22) Filed: Jul. 27, 2021

(30) Foreign Application Priority Data
Dec. 10, 2020 (JP) 2020-204985
Apr. 7, 2021 (JP) 2021-065282

(51) Int. Cl. F16L 19/00; F16L 19/02; F16L 19/025

(52) U.S. Cl. CPC F16L 19/005; F16L 33/30; F16L 19/025; F16L 19/0237

(57) ABSTRACT

A joint that is coupled to a cylindrical fluid discharger whose peripheral edge expands radially outward. The joint includes a cylindrical coupler that is coupled to the fluid discharger and has a male screw on an outer peripheral surface thereof, an engager that engages with the peripheral edge, and a tubular body that has a female screw to be coupled to the male screw on an inner peripheral surface thereof, and switches between a first state in which the attachment and the detachment of the fluid discharger and the joint are allowed and a second state in which the attachment and the detachment of the fluid discharger and the joint are restricted.

### CROSS-REFERENCE TO RELATED APPLICATION

This application is based upon and claims the benefit of priority of the prior Japanese Patent Application No. 2020-204985, filed on Dec. 10, 2020, and Japanese Patent Application No. 2021-065282, filed on Apr. 7, 2021, the entire contents of which are incorporated herein by reference.

### TECHNICAL FIELD

The present disclosure relates to a joint.

### BACKGROUND

An oil pan is provided at the bottom of an engine mounted on a motorcycle, an automobile, a heavy machinery, or the like. Oil that lubricates pistons and other parts of the engine is stored in the oil pan. The oil is changed regularly. When changing the oil, a tool such as a spanner is used to remove a screw lid of a drain port provided at the bottom of the oil pan.

When the screw lid of the drain port is removed, the oil spurts out at the same time. This may cause the operator's body to become dirty with the oil. When closing the drain port with the screw lid after the oil has been drained, the screw lid and the tools may be covered with the oil, and it may take time and effort to attach the screw lid to the drain port.

As a device for eliminating such inconveniences associated with oil change, there is known an operation valve that can be attached to the drain port as well as the screw lid. The operation valve is always attached to the drain port, and the opening and closing of the valve can be controlled by rotating an operation cock. In the normal state, the operation cock is maintained in a closed state and the valve is closed. When the operation cock is rotated in the open state, the valve opens and the oil is discharged.

Further, a resin joint can be coupled to a portion of the operation valve including an oil discharge port (hereinafter, referred to as a fluid discharge portion). There are various shapes of joints such as a bent shape and a straight shape. For example, when the direction of oil discharge is not downward, the direction of oil discharge can be guided downward by coupling a joint having the bent shape (see Japanese Unexamined Patent Application Publications No. 2002-106731 and No. 2017-36828).

### SUMMARY

An object of the present disclosure is to provide a joint that is coupled to a cylindrical fluid discharger whose peripheral edge expands radially outward, the joint including: a cylindrical coupler that is coupled to the fluid discharger and has a male screw on an outer peripheral surface thereof; an engager that engages with the peripheral edge; and a tubular body that has a female screw to be coupled to the male screw on an inner peripheral surface thereof; and switches between a first state in which the attachment and the detachment of the fluid discharger and the joint are allowed and a second state in which the attachment and the detachment of the fluid discharger and the joint are restricted.

Another object of the present disclosure is to provide a joint that is coupled to a cylindrical fluid discharger whose peripheral edge expands radially outward, the joint including: a cylindrical coupler that is coupled to the fluid discharger and has a ring-shaped first groove on an inner peripheral surface thereof; and a C-ring housed in the first groove and engaged with the peripheral edge.

### BRIEF DESCRIPTION OF THE DRAWINGS

FIG. 1 is a perspective view illustrating an example of attaching a joint to an operation valve:

FIGS. 2A and 2B are exploded perspective views of the joint according to a first embodiment;

FIG. 3A is an exploded cross-sectional view taken along line Z1-Z1 of the joint illustrated in FIGS. 2A and 2B:

FIG. 3B is a diagram illustrating a first state of the joint according to the first embodiment:

FIG. 3C is a diagram illustrating a second state of the joint according to the first embodiment:

FIGS. 4A and 4B are exploded perspective views of a joint according to a second embodiment;

FIG. 5A is an exploded cross-sectional view taken along line Z2-Z2 of the joint illustrated in FIGS. 4A and 4B;

FIG. 5B is a diagram illustrating a first state of the joint according to a second embodiment;

FIG. 5C is a diagram illustrating a second state of the joint according to the second embodiment;

FIG. 5D is an enlarged view of a cylinder;

FIGS. 6A and 6B are exploded perspective views of a joint according to a third embodiment;

FIG. 7A is an exploded cross-sectional view taken along line Z3-Z3 of the joint illustrated in FIGS. 6A and 6B;

FIG. 7B is a diagram illustrating a first state of the joint according to a third embodiment:

FIG. 7C is a diagram illustrating a second state of the joint according to the third embodiment;

FIG. 7D is an enlarged view of a cylinder and a ring member,

FIG. 8A is a first perspective view of a joint coupled with an operation valve according to a fourth embodiment:

FIG. 8B is a second perspective view of the joint according to the fourth embodiment;

FIG. 9A is a cross-sectional view taken along line Z4-Z4 of the operation valve and the joint illustrated in FIG. 8A before coupling; and

FIG. 9B is a cross-sectional view taken along line Z4-Z4 of the operation valve and the joint illustrated in FIG. 8A after coupling.

### DETAILED DESCRIPTION

As described above, the joint that can be coupled to the fluid discharge portion is made of resin. If the hardness of the resin is increased in order to secure firm coupling, it becomes difficult to attach/detach the joint to/from the fluid discharge portion. On the other hand, if the hardness of the resin is decreased to ensure easy attachment/detachment, the joint comes off from the fluid discharge portion during the oil change operation.

It is an object of the present disclosure to provide a joint that performs easy attachment/detachment and has firm coupling.

A description will be given of embodiments of the present disclosure, with reference to drawings.

### First Embodiment

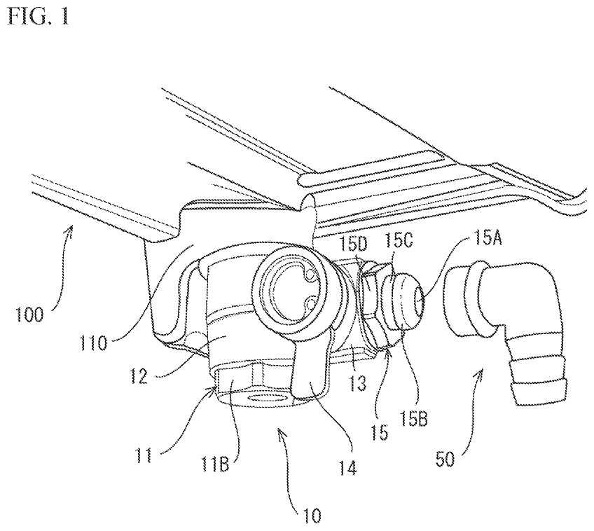

First, an operation valve 10 to be coupled to a joint 50 will be described. As illustrated in FIG. 1, the operation valve 10 is attached to a drain port 110 provided at the bottom of an oil pan 100. The oil pan 100 is a container for storing an oil. The drain port 110 is an opening for discharging the oil stored in the oil pan 100. The oil is a lubricating oil that lubricates pistons and other parts in an engine mounted on a motorcycle, an automobile, a heavy machinery, or the like. A female screw not illustrated in FIG. 1 is provided on an inner peripheral surface of the drain port 110.

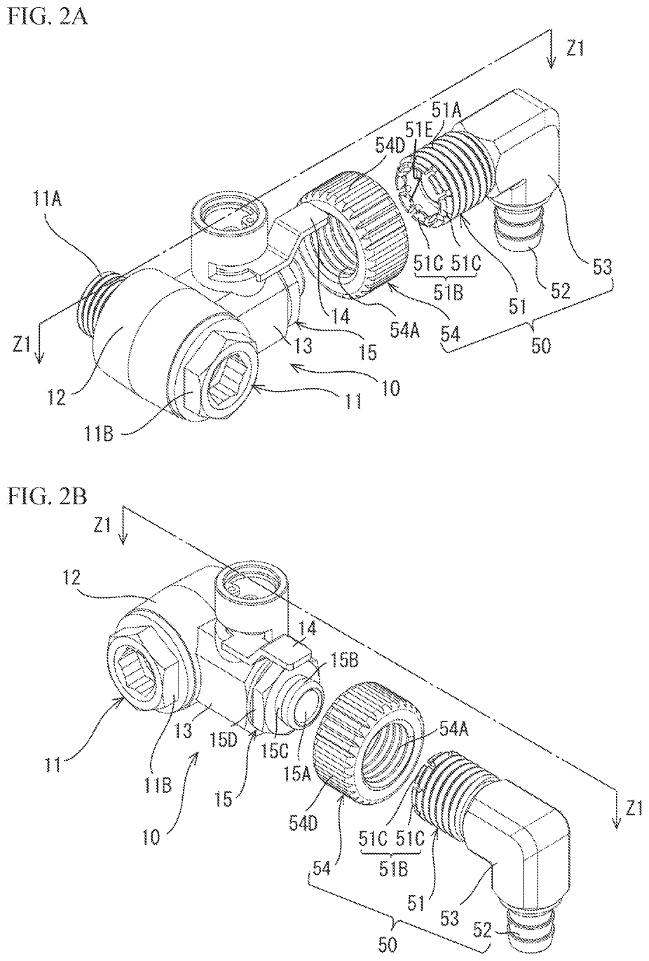

When the operation valve 10 is attached to the drain port 110, a hexagon bolt 11 of the operation valve 10 is screwed into the drain port 110. The hexagon bolt 11 is made of a resin or a metal containing duralumin alloy. As illustrated in FIG. 2A, a tip of a bolt shaft portion 11A of the hexagon bolt 11 projects from a hollow housing portion 12 included in the operation valve 10. That is, the housing portion 12 houses a portion other than the tip of the bolt shaft portion 11A.

Inside the bolt shaft portion 11A, a flow passage through which the oil flows is formed in an axial direction of the bolt shaft portion 11A. The oil in the oil pan 100 flows into the flow passage from an inlet of the flow passage and flows out from an outlet of the flow passage. The outlet of the flow passage is perpendicular to the flow passage. In other words, the outlet of the flow passage is formed perpendicular to the axial direction of the bolt shaft portion 11A. Thereby, an oil flow direction changes from a vertical direction to a horizontal direction.

A male screw is provided on an outer peripheral surface of the bolt shaft portion 11A. By connecting a tool such as a spanner to a bolt head 11B of the hexagon bolt 11 and rotating the bolt head 11B in a circumferential direction, the male screw of the bolt shaft portion 11A and the female screw of the drain port 110 are fastened. Thereby, the operation valve 10 can be attached to the drain port 110.

The operation valve 10 includes a storage portion 13. The storage portion 13 has a communication passage that communicates with the outlet of the flow passage inside. The storage portion 13 protrudes in a direction orthogonal to the longitudinal direction of the housing portion 12 with respect to an outer peripheral surface of the housing portion 12 as a reference surface. The communication passage provided inside the storage portion 13 extends in a protrusion direction of the storage portion 13. A valve is provided in the middle of the communication passage. The valve can be opened and closed by rotating an operation cock 14 provided on an outer peripheral surface of the storage portion 13. For example, when the operation cock 14 is rotated in a direction closer to the bolt head 11B of the hexagon bolt 11, the valve opens. Conversely, when the operation cock 14 is rotated in a direction away from the bolt head 11B of the hexagon bolt 11, the valve closes.

A fluid discharge portion 15 is provided at the tip of the storage portion 13 in the protrusion direction. A fluid passage continuous with the above-mentioned communication passage is formed inside the fluid discharge portion 15. Therefore, when the above-mentioned valve is opened, the oil is discharged from a fluid discharge port 15A (see FIG. 2B) which is the outlet of the fluid passage. On the contrary, when the valve is closed, the oil discharge from the fluid discharge port 15A is stopped.

As illustrated in FIG. 1, the joint 50 made of resin can be mechanically coupled to the fluid discharge portion 15. That is, the joint 50 is a mechanical joint. Further, since the joint 50 is mechanically coupled to the fluid discharge portion 15, the joint 50 may be referred to as a mechanical fluid joint. The fluid discharge section 15 includes a cylindrical protrusion 15C including an expansion portion 15B whose tip peripheral edge expands outward in the radial direction, and a pedestal portion 15D on which the base end of the protrusion 15C is installed. The details thereof will be described later. The joint 50 is coupled to the fluid discharge portion 15 by housing and engaging the expansion portion 15B included in the protrusion 15C inside.

In the present embodiment, the joint 50 having a bent shape or L-shape (hereinafter, simply referred to as a bent shape) is illustrated as an example. Coupling the bent-shaped joint 50 to the operation valve 10 can, for example, guide the direction of oil discharge downward if the direction of oil discharge is not downward.

The shape of the joint 50 may be a linear shape (or an I-shape), a spiral shape, a crank shape, an arc shape, or the like. Since the joint 50 is made of resin, it can be easily processed into various shapes.

The details of the configuration of the joint 50 according to the first embodiment will be described with reference to FIGS. 2A and 2B. The joint 50 integrally has a coupling portion 51 that is coupled to the fluid discharge portion 15, a connection portion 52 to which a discharge pipe such as a hose is connected, and a joint body 53 that connects the coupling portion 51 to the connection portion 52. Since the coupling portion 51, the connection portion 52 and the joint body 53 are all tubular (or hollow), the oil can flow through them. Further, the joint 50 has a tubular body 54 which is separated from the coupling portion 51, the connection portion 52 and the joint body 53. In FIGS. 2A and 2B, the shape of the tubular body 54 is illustrated as a cylindrical body, but the shape of the tubular body 54 may be a polygonal tubular body. That is, an outer shape of a cross section of the tubular body 54 may be circular or polygonal including a hexagon. In first to fourth embodiments, since the coupling portions 51, 61, 71, 81, the tubular body 54, 64, 74, and a ring member 75 are tubular shapes, each of lines passing through the center of these tubular shapes is a central axis, a direction in which the central axis extends is an axial direction, a direction toward the central axis is a diameter reducing direction, and a direction from the central axis outward is a diameter expanding direction.

The coupling portion 51 has a cylindrical shape, and a male screw 51A is formed on an outer peripheral surface of the coupling portion 51. Further, an engaging portion 51B that engages with the expansion portion 15B is formed on a peripheral edge of the coupling portion 51 opposite to the joint body 53. The engaging portion 51B according to the first embodiment includes a plurality of claws 51C extending in the direction of the expansion portion 15B of the fluid discharge portion 15. A male screw continuous with the male screw 51A is also formed on an outer peripheral surface of each of the plurality of claws 51C. The plurality of claws 51C are provided integrally with the coupling portion 51 on the peripheral edge of the coupling portion 51 in a state of being separated from each other by narrow gaps or slits. The plurality of claws 51C engage with the expansion portion 15B, thereby coupling the coupling portion 51 to the fluid discharge portion 15.

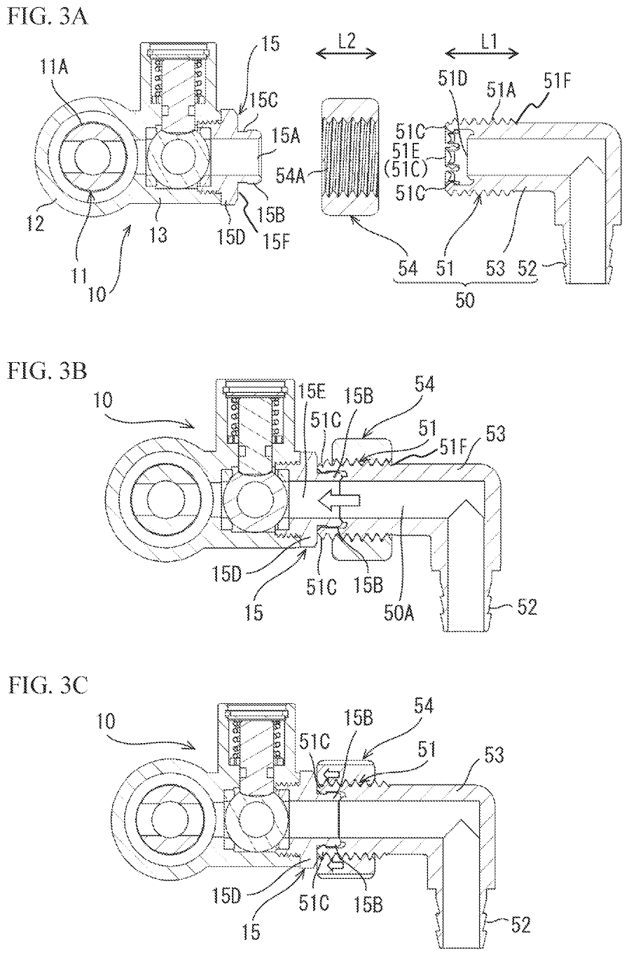

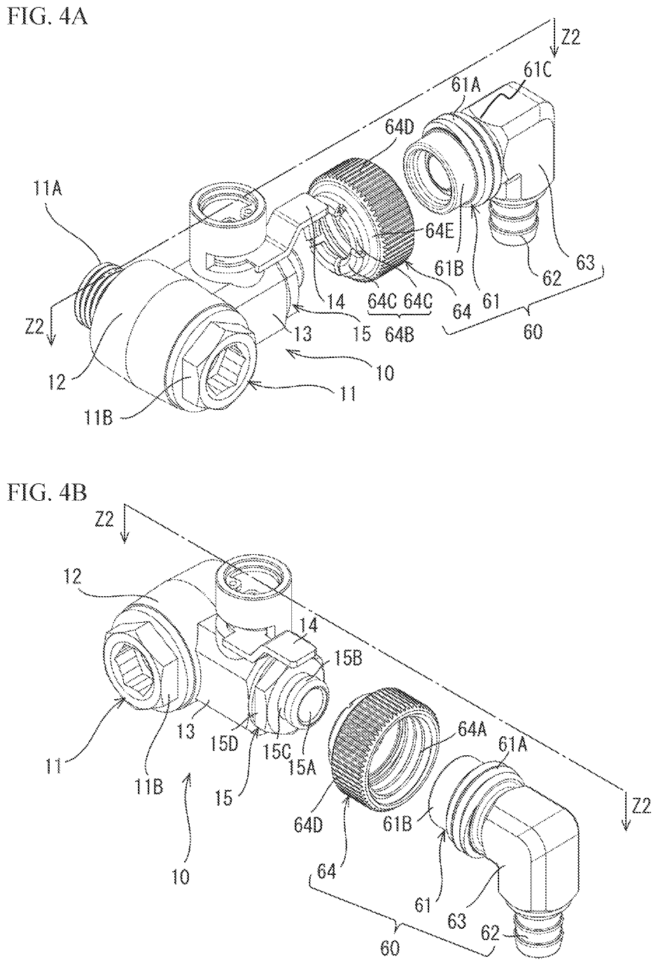

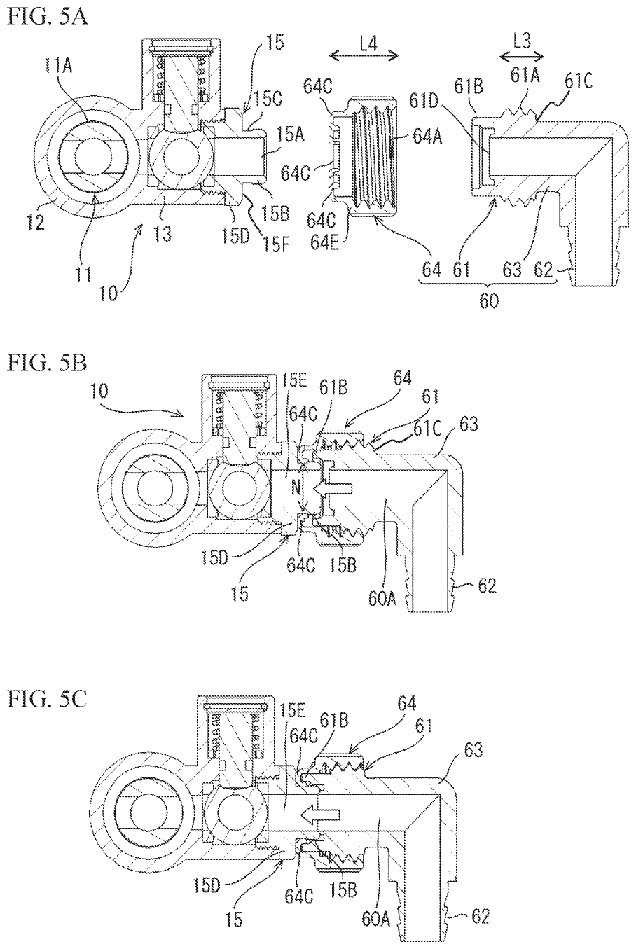

The tubular body 54 has a female screw 54A in a circumferential direction of an inner peripheral surface, and has an unevenness 54D extending in the axial direction of the tubular body 54 on an outer peripheral surface. The female screw 54A is fastened to the male screw 51A formed on the outer peripheral surface of the coupling portion 51. Since the unevenness 54D is formed on the outer peripheral surface of the tubular body 54, when the tubular body 54 is fastened to the coupling portion 51, the slippage of the operator's fingers is suppressed as compared with the case where the unevenness 54D is not formed. The tubular body 54 can be smoothly fastened to the coupling portion 51. Although details will be described later, the tubular body 54 switches between a first state in which the attachment and the detachment of the fluid discharge portion 15 and the joint 50 are allowed, and a second state in which the attachment and the detachment of the fluid discharge portion 15 and the joint 50 are restricted. As illustrated in FIG. 3A, a length L1 of the male screw 51A is longer than a length L2 of the female screw 54A in the axial direction of the coupling portion 51 or the tubular body 54.

The details of the operation of the joint 50 according to the first embodiment will be described with reference to FIGS. 3A to 3C. When the tubular body 54, which is a separate body from the coupling portion 51, is separated from the coupling portion 51 as illustrated in FIG. 3A, the tubular body 54 is fastened to the coupling portion 51. Specifically, the tubular body 54 is rotated clockwise in the circumferential direction of the tubular body 54 in a state where the tubular body 54 is brought close to the coupling portion 51 and brought into contact with the coupling portion 51. The female screw 54A is formed on the inner peripheral surface of the tubular body 54, and the male screw 51A is formed on the outer peripheral surface of the coupling portion 51. Therefore, when the tubular body 54 is rotated, the female screw 54A and the male screw 51A engage with each other, and the tubular body 54 is fastened to the coupling portion 51. As illustrated in FIG. 3B, the tubular body 54 is continuously rotated to move the tubular body 54 until it reaches a base end portion 51F which is a connecting portion between the coupling portion 51 and the joint body 53. When the tubular body 54 moves to the base end portion 51F, it becomes an attachable state included in the first state described above, and the plurality of claws 51C protrude from the tubular body 54.

Next, in the attachable state, the joint body 53 is moved toward the operation valve 10 as illustrated by a void arrow in FIG. 3B. The joint body 53 is pushed toward the operation valve 10 in a state where the joint body 53 is moved toward the operation valve 10 and the plurality of claws 51C are in contact with the expansion portion 15B of the fluid discharge portion 15. Here, a convexity 51E protruding toward the central axis of the coupling portion 51 (in the diameter reducing direction) is formed on an inner tip portion of each of the plurality of claws 51C. The degree of protrusion of the convexity 51E and the degree of expansion of the expansion portion 15B correspond to each other, and are specifically the same degree as each other. That is, an outer diameter of the expansion portion 15B and an inner diameter of a circle composed of portions excluding the convexities 51E in the plurality of claws 51C are substantially the same as each other. The inner diameter of a circle formed by the tips of the convexities 51E in the plurality of claws 51C is smaller than the outer diameter of the expansion portion 15B.

Thus, since the convexity 51E is formed on the inner tip of each of the plurality of claws 51C, and the plurality of claws 51C are separated from each other by the narrow gaps, while the tips of the plurality of claws 51C are getting over the expansion portion 15B, the plurality of claws 51C transitions to a diameter expanding state which represents a state in which a diameter temporarily expands outward the coupling portion 51. That is, the transition of the plurality of claws 51C to the diameter expanding state is allowed. When the tips of the plurality of claws 51C finish getting over the expansion portion 15B, the plurality of claws 51C return from the diameter expanding state to an original state before the diameter expanding state. Thereby, the plurality of claws 51C engage with the expansion portion 15B, and the plurality of claws 51C come into contact with a seat surface 15F of the pedestal portion 15D in the fluid discharge portion 15 or are separated from the seat surface 15F of the pedestal portion 15D. Further, the plurality of claws 51C engage with the expansion portion 15B, and the fluid discharge port 15A and a fluid inflow port 51D of the coupling portion 51 (see FIG. 3A) come into contact with each other. When the fluid discharge port 15A and the fluid inflow port 51D come into contact with each other, a fluid passage 15E provided inside the fluid discharge portion 15 and a joint passage 50A provided inside the joint 50 are coupled to each other. As a result, a detachable state included in the first state is obtained.

As described above, in the attachable state, the joint 50 can be easily attached to the operation valve 10 by the plurality of claws 51C separated from each other by the narrow gaps. If the joint body 53 is moved away from the operation valve 10 in the detachable state, the joint 50 can be easily detached from the operation valve 10 in a reverse order of the above description. That is, the joint 50 according to the first embodiment can ensure easy attachment to or detachment from the operation valve 10.

As illustrated in FIG. 3C, the tubular body 54 is rotated counterclockwise in the circumferential direction of the tubular body 54 in a state where the plurality of claws 51C are engaged with the expansion portion 15B. Thereby, the tubular body 54 moves toward the fluid discharge portion 15, as illustrated by void arrows in FIG. 3C. When the rotation of the tubular body 54 is continued, the tubular body 54 comes into contact with the seat surface 15F of the pedestal portion 15D. Thereby, the above-mentioned first state is switched to the above-mentioned second state.

Here, when the joint body 53 is moved away from the operation valve 10 in order to detach the joint 50 from the operation valve 10 in the second state illustrated in FIG. 3C, the tips of the plurality of claws 51C get over the expansion portion 15B and the plurality of claws 51C try to shift to the diameter expanding state. However, since the tubular body 54 restricts the transition of the plurality of claws 51C to the diameter expanding state, the plurality of claws 51C cannot shift to the diameter expanding state. That is, when the plurality of claws 51C are engaged with the expansion portion 15B and the tubular body 54 is in contact with the seat surface 15F of the pedestal portion 15D, the joint 50 cannot be detached from the operation valve 10. In this way, the joint 50 according to the first embodiment can secure firm coupling to the operation valve 10.

### Second Embodiment

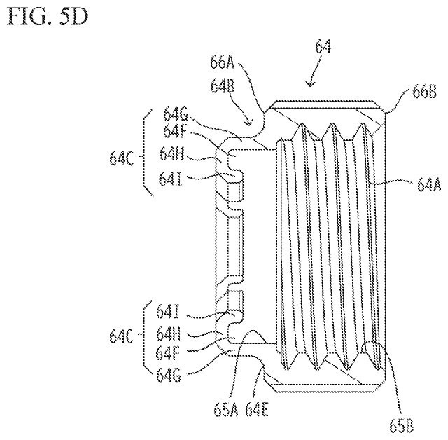

Next, a second embodiment of the present disclosure will be described with reference to FIGS. 4A and 4B and FIGS. 5A to 5D. The same components as those of the operation valve 10 described in the first embodiment are designated by the same reference numerals, and the description thereof will be omitted. This also applies to the third embodiment described later.

First, the details of the configuration of a joint 60 according to the second embodiment will be described with reference to FIGS. 4A and 4B. The joint 60 integrally has a coupling portion 61 coupled to the fluid discharge portion 15, a connection portion 62 to which the discharge pipe is connected, and a joint body 63 that connects the coupling portion 61 to the connection portion 62. Since the coupling portion 61, the connection portion 62 and the joint body 63 are all tubular (or hollow), the oil can flow through them. Further, the joint 60 has a tubular body 64 which is separated from the coupling portion 61, the connection portion 62 and the joint body 63. In FIGS. 4A and 4B, the shape of the tubular body 64 is illustrated as a cylindrical body, but the shape of the tubular body 64 may be a polygonal tubular body. That is, an outer shape of a cross section of the tubular body 64 may be circular or polygonal including a hexagon.

The coupling portion 61 has a cylindrical shape, and a male screw 61A is formed on an outer peripheral surface of the coupling portion 61. An outer diameter of a screw groove portion of the male screw 61A is a minimum diameter of the male screw 61A, and the minimum diameter is formed to be larger than the outer diameter of a coupling end 61B located at the tip of the coupling portion 61 (specifically, see FIG. 5A). The male screw 61A is partially formed from a base end portion 61C, which is a connection portion between the coupling portion 61 and the joint body 63, toward the coupling end 61B. As described above, unlike the first embodiment, the male screw 61A is formed not on an entire outer peripheral surface of the coupling portion 61 but on a part of the outer peripheral surface.

The tubular body 64 has a female screw 64A in a circumferential direction of an inner peripheral surface, and has an unevenness 64D extending in the axial direction of the tubular body 64 on an outer peripheral surface. The female screw 64A is fastened to the male screw 61A formed on the outer peripheral surface of the coupling portion 61. Since the unevenness 64D is formed on the outer peripheral surface of the tubular body 64, the tubular body 64 can be smoothly fastened to the coupling portion 61 as in the first embodiment.

Further, as illustrated in FIG. 5D, a circular plate portion 64E having a circular opening 65A (first opening) at its center is provided on one outer peripheral edge 66A of the tubular body 64. When the shape of the tubular body 64 is a polygonal tubular body, the circular plate portion 64E may be changed to a polygonal plate portion corresponding to the cross-sectional shape of the polygonal tubular body. The outer diameter of the circular plate portion 64E is the same as the inner diameter of the outer peripheral edge 66A. That is, an opening 65B (second opening) of the tubular body 64 is partially closed by the circular plate portion 64E. An engaging portion 64B is provided on a peripheral edge of the opening 65A in the circular plate portion 64E. The engaging portions 64B according to the second embodiment includes a plurality of claws (AC that are curved toward the central axis of the tubular body 64 and are separated from each other by the narrow gaps. The plurality of claws 64C are integrally provided with the circular plate portion 64E on the peripheral edge of the opening 65A in the circular plate portion 64E. Each claw 64C includes an outer peripheral portion 64G that extends along the central axis of the tubular body 64 from the peripheral edge of the opening 65A in the circular plate portion 64E, a curved portion 64H that is connected to one end of the outer peripheral portion 64G and curved from the outer peripheral portion 64G toward the central axis of the tubular body 64, and a tip portion 64I that is connected to one end of the curved portion 64H and formed substantially parallel to the outer peripheral portion 64G A recess 64F surrounded by the outer peripheral portion 64G the curved portion 64H and the tip portion 64I, that is, the recess 64F located inside the claw 64C can house the coupling end 61B located at the tip of the coupling portion 61. The cross-sectional shape of each claw 64C (that is, the outer peripheral portion 64G the curved portion 64H and the tip portion 64I) is a U-shape or J-shape. In the axial direction of the tubular body 64, the length of the tip portion 64I is shorter than the length of the outer peripheral portion 64C but the tip portion 64I and the outer peripheral portion 64G may have substantially the same length. The plurality of claws 64C engage the expansion portion 15B, which couples the coupling portion 61 to the fluid discharge portion 15. Although details will be described later, the tubular body 64 switches between a first state in which the attachment and the detachment of the fluid discharge portion 15 and the joint 60 are allowed, and a second state in which the attachment and the detachment of the fluid discharge portion 15 and the joint 60 are restricted. Further, as illustrated in FIG. 5A, a length L3 of the male screw 61A is shorter than a length L4 of the tubular body 64 in the axial direction of the coupling portion 61 or the tubular body 64. The lengths of the male screw 61A and the female screw 64A are substantially the same.

The details of the operation of the joint 60 according to the second embodiment will be described with reference to FIGS. 5A to 5D. When the tubular body 64, which is a separate body from the coupling portion 61 or the like, is separated from the coupling portion 61 as illustrated in FIG. 5A, the tubular body 64 is first fastened to the coupling portion 61. Specifically, the tubular body 64 is rotated clockwise in the circumferential direction of the tubular body 64 in a state where the tubular body 64 is brought close to the coupling portion 61 and brought into contact with the coupling portion 61. The female screw 64A is formed on the inner peripheral surface of the tubular body 64, and the male screw 61A is partially formed on the outer peripheral surface of the coupling portion 61. Therefore, when the tubular body 64 is rotated, the female screw 64A and the male screw 61A engage with each other, and the tubular body 64 is fastened to the coupling portion 61. As illustrated in FIG. 5B, the tubular body 64 is continuously rotated to move the tubular body 64 to an intermediate position where it does not reach the base end portion 61C which is a connecting portion between the coupling portion 61 and the joint body 63. When the tubular body 64 moves to the intermediate position, it becomes an attachable state included in the first state described above.

Next, in the attachable state, the joint body 63 is moved toward the operation valve 10 as illustrated by avoid arrow in FIG. 5B. The joint body 63 is pushed toward the operation valve 10 in a state where the joint body 63 is moved toward the operation valve 10 and the plurality of claws 64C are in contact with the expansion portion 15B of the fluid discharge portion 15. Here, each of the plurality of claws 64C is curved in a U-shape or a J-shape toward the central axis of the tubular body 64. An inner diameter N, which represents a distance between the tip portion 64I of a first claw included in the plurality of claws 64C and the tip portion 64I of a second claw located at a point symmetrical to the tip portion 64I of the first claw with respect to the central axis of the tubular body 64, is smaller than the outer diameter of the expansion portion 15B. That is, the outer diameter of the expansion portion 15B is less than the inner diameter of a circle formed of the outer peripheral portion 64G but the inner diameter N of a circle formed of the tip portions 64I of the plurality of claws 64C is less than the outer diameter of the expansion portion 15B.

Thus, since each of the plurality of claws 64C is curved in the axial direction of the coupling portion 61 and the plurality of claws 64C are separated from each other by the narrow gaps, while the tip portions of the plurality of claws 64C are getting over the expansion portion 15B, the plurality of claws 64C transitions to the diameter expanding state which represents a state in which the roots of the plurality of claws 64C bend and the inner diameter N temporarily expands outward the coupling portion 61. That is, since the coupling end 61B is retracted from the recesses 64F located inside the plurality of claws 64C, the plurality of claws 64C can be bent, and the transition of the plurality of claws 64C to the diameter expanding state is allowed. When the tip portions 64I of the plurality of claws 64C finish getting over the expansion portion 15B, the plurality of claws 64C return from the diameter expanding state to the original state before the diameter expanding state. Thereby, the plurality of claws 64C engage with the expansion portion 15B, and the curved portions 64H of the plurality of claws (AC come into contact with the seat surface 15F of the pedestal portion 15D in the fluid discharge portion 15 or are separated from the seat surface 15F of the pedestal portion 15D. When the plurality of claws 64C engage with the expansion portion 15B, the detachable state included in the first state is obtained.

In this way, when the joint 60 is in the attachable state, the joint 60 can be easily attached to the operation valve 10 by the plurality of claws 64C separated from each other by the narrow gaps. When the joint 60 is in the detachable state and the joint body 63 is moved away from the operation valve 10, the joint 60 can be easily detached from the operation valve 10 in a reverse order of the above description. That is, the joint 60 according to the second embodiment can ensure easy attachment to or detachment from the operation valve 10.

As illustrated in FIG. 5B, the tubular body 64 is rotated counterclockwise in the circumferential direction of the tubular body 64 in a state where the plurality of claws 64C are engaged with the expansion portion 15B. Thereby, the coupling portion 61 moves toward the fluid discharge portion 15 together with the connection portion 62 and the joint body 63, as illustrated by the void arrow in FIG. 5C. When the rotation of the tubular body 64 is continued, the base end portion 61C reaches the other outer peripheral edge 66B (FIG. 5D) in the tubular body 64. When the base end portion 61C reaches the other outer peripheral edge 66B, the coupling end 61B is housed in the recess 64F, and the fluid discharge port 15A and a fluid inflow port 61D of the coupling portion 61 (see FIG. 5A) come into contact with each other. Thereby, the above-mentioned first state is switched to the above-mentioned second state. When the fluid discharge port 15A and the fluid inflow port 61D come into contact with each other, the fluid passage 15E provided inside the fluid discharge portion 15 and a joint passage 60A provided inside the joint 60 are coupled to each other.

Here, when the joint body 63 is moved away from the operation valve 10 in order to detach the joint 60 from the operation valve 10 in the second state illustrated in FIG. 5C, the tip portions 61I of the plurality of claws 64C get over the expansion portion 15B and the plurality of claws 64C try to shift to the diameter expanding state. However, since the coupling end 61B is housed in the recess 64F, the plurality of claws 64C cannot bend inward of the claws. That is, the coupling end 61B restricts the transition of the inner diameter N of the plurality of claws 64C to the diameter expanding state, and the inner diameter N of the plurality of claws 64C cannot shift to the diameter expanding state.

Thus, when the plurality of claws 64C are engaged with the expansion portion 15B and the coupling end 61B is housed in the recess 64F, the joint 60 cannot be detached from the operation valve 10. In this way, the joint 60 according to the second embodiment can secure firm coupling to the operation valve 10. In particular, according to the second embodiment, as the tubular body 64 rotates, the coupling portion 61 can be brought closer to the fluid discharge portion 15 together with the connection portion 62 and the joint body 63. Therefore, unlike the first embodiment, when the tubular body 64 is tightened, a gap between the fluid passage 15E and the joint passage 60A can be closed. That is, in the second embodiment, a sealability between the fluid passage 15E and the joint passage 60A can be improved as compared with the first embodiment, and the oil can be guided without leaking.

### Third Embodiment

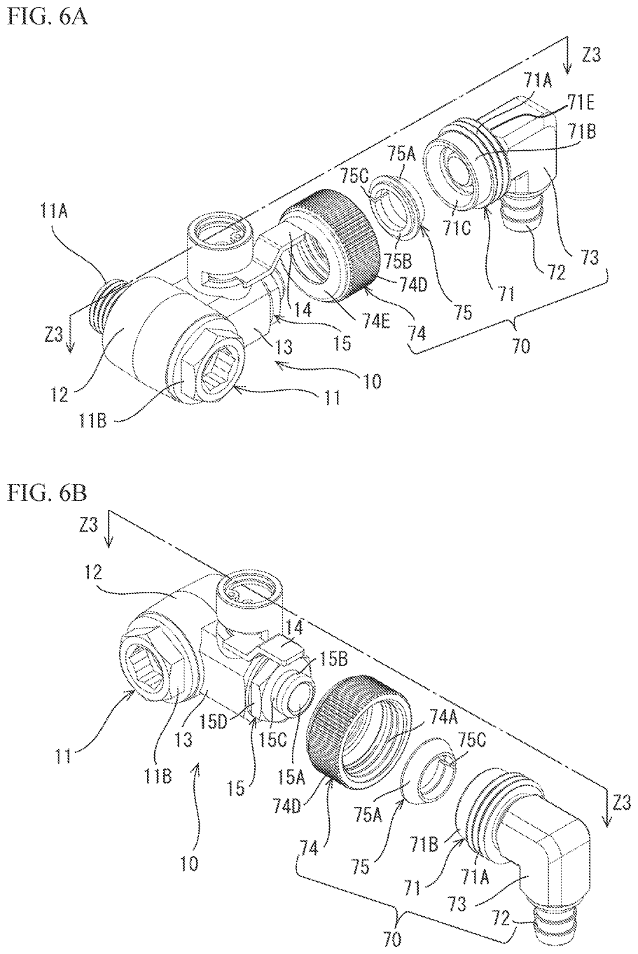

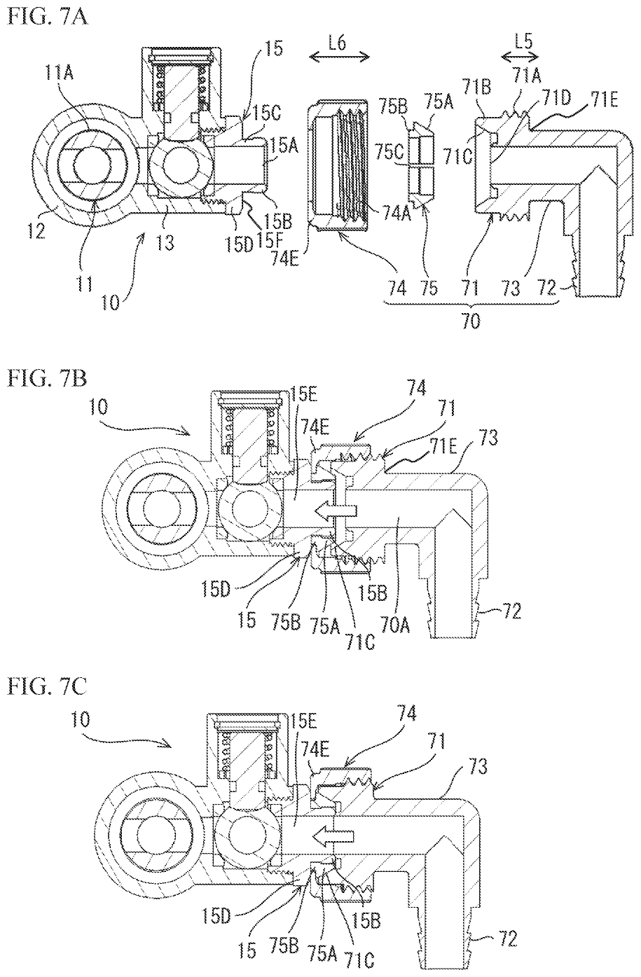

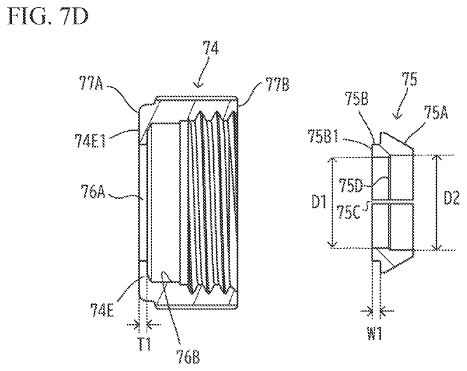

Next, a third embodiment of the present disclosure will be described with reference to FIGS. 6A and 6B and FIGS. 7A to 7D.

First, the details of the configuration of a joint 70 according to the third embodiment will be described with reference to FIGS. 6A and 6B. The joint 70 integrally has a coupling portion 71 coupled to the fluid discharge portion 15, a connection portion 72 to which the discharge pipe is connected, and a joint body 73 that connects the coupling portion 71 to the connection portion 72. Since the coupling portion 71, the connection portion 72 and the joint body 73 are all tubular (or hollow), the oil can flow through them. Further, the joint 70 has a tubular body 74 and a ring member which are separated from the coupling portion 71, the connection portion 72 and the joint body 73. In FIGS. 6A and 6B, the shape of the tubular body 74 is illustrated as a cylindrical body, but the shape of the tubular body 74 may be a polygonal tubular body. That is, an outer shape of a cross section of the tubular body 74 may be circular or polygonal including a hexagon.

The coupling portion 71 has a cylindrical shape, and a male screw 71A is formed on an outer peripheral surface of the coupling portion 71. As in the second embodiment, an outer diameter of a screw groove portion of the male screw 71A is a minimum diameter of the male screw 71A, and the minimum diameter is formed to be larger than the outer diameter of a coupling end 71B located at the tip of the coupling portion 71. The male screw 71A is partially formed from abase end portion 71E, which is a connection portion between the coupling portion 71 and the joint body 73, toward the coupling end 71B. As described above, as in the second embodiment, the male screw 71A is formed not on an entire outer peripheral surface of the coupling portion 71 but on a part of the outer peripheral surface.

The tubular body 74 has a female screw 74A in a circumferential direction of an inner peripheral surface, and has an unevenness 74D extending in the axial direction of the tubular body 74 on an outer peripheral surface. The female screw 74A is fastened to the male screw 71A formed on the outer peripheral surface of the coupling portion 71. Since the unevenness 74D is formed on the outer peripheral surface of the tubular body 74, the tubular body 74 can be smoothly fastened to the coupling portion 71 as in the first embodiment. Further, a circular plate portion 74E having a circular opening 76A (first opening) at its center is provided on one outer peripheral edge 77A of the tubular body 74 (see FIG. 7D). When the shape of the tubular body 74 is a polygonal tubular body, the circular plate portion 74E may be changed to a polygonal plate portion corresponding to the cross-sectional shape of the polygonal tubular body. The outer diameter of the circular plate portion 74E is the same as the inner diameter of the outer peripheral edge 77A. That is, an opening 76B (second opening) of the tubular body 74 is partially closed by the circular plate portion 74E. Although details will be described later, the tubular body 74 switches between a first state in which the attachment and the detachment of the fluid discharge portion 15 and the joint 70 are allowed, and a second state in which the attachment and the detachment of the fluid discharge portion 15 and the joint 70 are restricted. Further, as illustrated in FIG. 7A, a length L5 of the male screw 71A is shorter than a length L6 of the tubular body 74 in the axial direction of the coupling portion 71 or the tubular body 74. The lengths of the male screw 71A and the female screw 74A are substantially the same.

The ring member 75 is arranged between the coupling portion 71 and the tubular body 74. The ring member 75 includes a ring-shaped tapered portion 75A and a cylindrical engaging portion 75B. The engaging portion 75B is provided on an end of the tapered portion 75A having a wider outer diameter among the two different outer diameters. The tapered portion 75A is arranged near the coupling portion 71, and the engaging portion 75B is arranged near the tubular body 74.

The tapered portion 75A and the engaging portion 75B are provided with one continuous cutout 75C penetrating in the axial direction of the ring member 75. The cutout 75C allows the diameter of the ring member 75 to be temporarily narrowed or widened. That is, when the two cross sections of the ring member 75 divided by the cutout 75C are brought into contact with each other, the diameter of the ring member 75 is narrowed, and when the two cross sections are separated from each other, the diameter of the ring member 75 is widened.

In a normal state where the diameter of the ring member 75 is neither narrowed nor widened, the outer diameter of the engaging portion 75B is substantially the same as or the same as the inner diameter of the opening 76A in the circular plate portion 74E provided on the tubular body 74 (specifically, see FIG. 7D). Further, a width W1 of the engaging portion 75B is substantially the same as or the same as a thickness T1 of the circular plate portion 74E in the peripheral edge of the opening 76A. Such a shape allows the engaging portion 75B to be fitted into the opening 76A in the circular plate portion 74E. Although details will be described later, an inner diameter D1 of the engaging portion 75B in a normal state is formed to be narrower than an inner diameter D2 of the tapered portion 75A. That is, a step 75D is provided on the inner peripheral surface of the ring member 75. The degree of expansion of the step 75D and the degree of expansion of the expansion portion 15B correspond to each other, and are specifically the same degrees as each other.

The details of the operation of the joint 70 according to the third embodiment will be described with reference to FIGS. 7A to 7D. When the tubular body 74 and the ring member 75, which are separate bodies from the coupling portion 71 or the like, is separated from the coupling portion 71 as illustrated in FIG. 5A, the ring member 75 is first fitted to the tubular body 74 and the tubular body 74 is fastened to the coupling portion 71. Specifically, the ring member 75 is first brought close to the tubular body 74, and the engaging portion 75B of the ring member 75 is fitted into the opening 76A in the circular plate portion 74E of the tubular body 74. Next, in a state where the ring member 75 is fitted to the tubular body 74, the tubular body 74 is brought into contact with the coupling portion 71, and in this state, the tubular body 74 is rotated clockwise in the circumferential direction of the tubular body 74.

The female screw 74A is formed on the inner peripheral surface of the tubular body 74, and the male screw 71A is partially formed on the outer peripheral surface of the coupling portion 71. Therefore, when the tubular body 74 is rotated, the female screw 74A and the male screw 71A engage with each other, and the tubular body 74 is fastened to the coupling portion 71. As illustrated in FIG. 7B, the tubular body 74 is continuously rotated to move the tubular body 74 to an intermediate position where it does not reach the base end portion 71E which is a connecting portion between the coupling portion 71 and the joint body 73. When the tubular body 74 moves to the intermediate position, it becomes an attachable state included in the first state described above.

Next, in the attachable state, the joint body 73 is moved toward the operation valve 10 as illustrated by avoid arrow in FIG. 7B. The joint body 73 is pushed toward the operation valve 10 in a state where the joint body 73 is moved toward the operation valve 10 and the engaging portion 75B of the ring member 75 is in contact with the expansion portion 15B of the fluid discharge portion 15. Here, since the inner diameter of the engaging portion 75B is substantially the same as or the same as the outer diameter of the expansion portion 15B, the engaging portion 75B can slide and pass through the expansion portion 15B. When the engaging portion 75B finishes passing through the expansion portion 15B, a tip surface 75B1 (FIG. 7D) of the engaging portion 75B and a plate surface 74E1 (FIG. 7D) of the circular plate portion 74E come in contact with the seat surface 15F of the pedestal portion 15D without a step, or separate from the seat surface 15F of the pedestal portion 15D. In the state illustrated in FIG. 7B, since the engaging portion 75B is not engaged with the expansion portion 15B, the detachable state included in the first state is obtained.

In this way, when the joint 70 is in the attachable state, the engaging portion 75B can slide and pass through the expansion portion 15B, and hence the joint 70 can be easily attached to the operation valve 10. When the joint 70 is in the detachable state and the joint body 73 is moved away from the operation valve 10, the joint 70 can be easily detached from the operation valve 10 in a reverse order of the above description. That is, the joint 70 according to the third embodiment can ensure easy attachment to or detachment from the operation valve 10.

As illustrated in FIGS. 7B and 7D, the tubular body 74 is rotated counterclockwise in the circumferential direction of the tubular body 74 in a state where the tip surface 75B1 of the engaging portion 75B and the plate surface 74E1 of the circular plate portion 74E come in contact with the seat surface 15F of the pedestal portion 15D or separate from the seat surface 15F of the pedestal portion 15D. Thereby, the coupling portion 71 moves toward the fluid discharge portion 15 together with the connection portion 72 and the joint body 73, as illustrated by the void arrow in FIG. 7C. When the rotation of the tubular body 64 is continued, the base end portion 71E reaches the other outer peripheral edge 77B (see FIG. 7D) in the tubular body 74.

In a process of the base end portion 71E reaching the other outer peripheral edge 77B, a tapered surface 71C provided inside the coupling end 71B slides in contact with the outer peripheral surface of the tapered portion 75A from a state of being separated from the outer peripheral surface of the tapered portion 75A of the ring member 75. Then, the tapered surface 71C presses the outer peripheral surface of the tapered portion 75A toward the central axis of the ring member 75. The tapered surface 71C and the outer peripheral surface of the tapered portion 75A have the same degree of taper (or gradient). When the outer peripheral surface of the tapered portion 75A is pressed toward the central axis of the ring member 75, the diameter of the ring member 75 narrows, the engaging portion 75B engages with the expansion portion 15B, and the fluid discharge port 15A and a fluid inflow port 71D of the coupling portion 71 (see FIG. 7A) come into contact with each other. Thereby, the above-mentioned first state is switched to the above-mentioned second state. When the fluid discharge port 15A and the fluid inflow port 71D come into contact with each other, the fluid passage 15E provided inside the fluid discharge portion 15 and a joint passage 70A provided inside the joint 70 are coupled to each other.

Here, when the joint body 73 is moved away from the operation valve 10 in order to detach the joint 70 from the operation valve 10 in the second state illustrated in FIG. 7C, the engaging portion 75B tries to pass through the expansion portion 15B. However, since the tapered surface 71C presses the outer peripheral surface of the tapered portion 75A toward the central axis of the ring member 75, the ring member 75 cannot return to the original normal state from a state where the diameter thereof is narrowed. That is, the tapered surface 71C restricts that the ring member 75 returns to the original normal state. Thereby, the engaging portion 75B cannot get over the expansion portion 15B and pass through the expansion portion 15B.

Thus, when the engaging portion 75B is engaged with the expansion portion 15B and the tapered surface 71C presses the outer peripheral surface of the tapered portion 75A toward the central axis of the ring member 75, the joint 70 cannot be detached from the operation valve 10. In this way, the joint 60 according to the third embodiment can secure firm coupling to the operation valve 10. According to the third embodiment, as the tubular body 74 rotates, the coupling portion 71 can be brought closer to the fluid discharge portion 15 together with the connection portion 72 and the joint body 73, as in the second embodiment. Therefore, in the third embodiment, a sealability between the fluid passage 15E and the joint passage 70A can be improved as compared with the first embodiment, and the oil can be guided without leaking.

### Fourth Embodiment

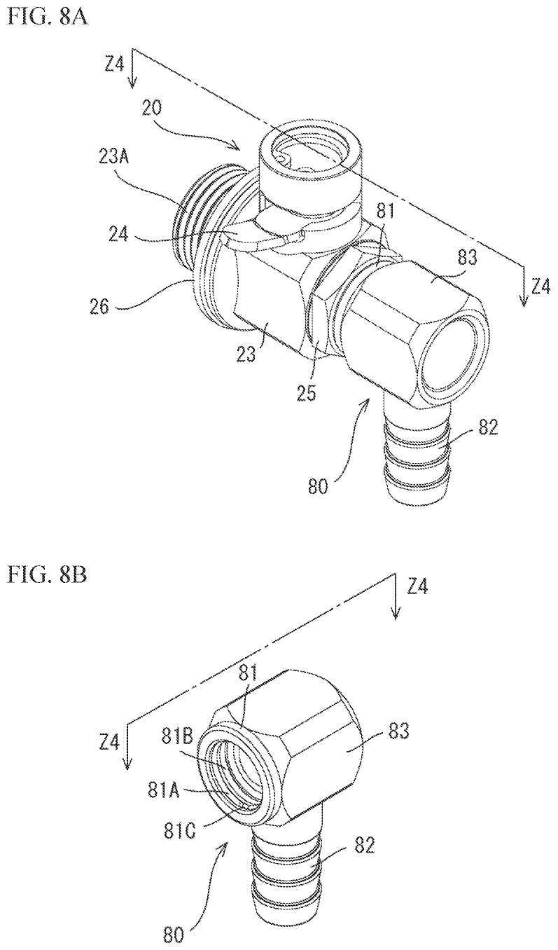

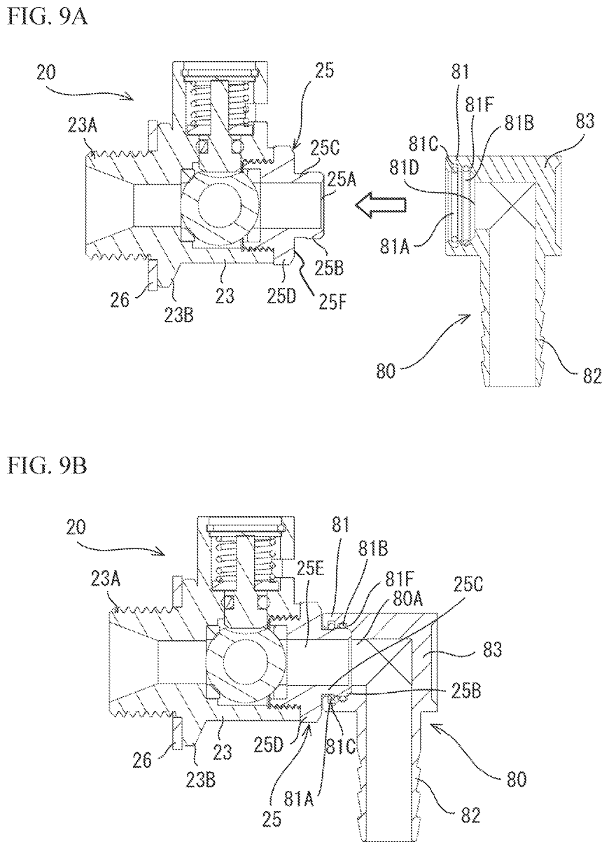

Next, a fourth embodiment of the present disclosure will be described with reference to FIGS. 8A and 8B and FIGS. 9A and 9B. Although the fourth embodiment will be described using an operation valve 20 having a shape different from the operation valve 10 described in the first embodiment and the like, the same components as those of the operation valve 10 are designated by the same reference numerals, and the description thereof will be omitted.

When the operation valve 20 is attached to the drain port 110 (see FIG. 1) as illustrated in FIG. 8A, a cylindrical attaching portion 23A integrally provided on a flange 23B provided in a housing portion 23 of the operation valve 20 is screwed into the drain port 110. A male screw is provided on the outer peripheral surface of the attaching portion 23A. Therefore, the male screw of the attaching portion 23A is fastened to the female screw of the drain port 110 by holding the housing portion 23 of the operation valve 20 in the hand and rotating the housing portion 23 in the circumferential direction. This allows the operation valve 20 to be attached to the drain port 110.

Since the attaching portion 23A has a cylindrical shape, the oil in the oil pan 100 passes through the inside of the attaching portion 23A and flows into the inside of the housing portion 23. By arranging a ring-shaped packing 26 at the base of the attaching portion 23A, the sealability between the drain port 110 and the attaching portion 23A can be improved. Thereby, even if there is a gap between the drain port 110 and the attaching portion 23A, oil leakage from the gap can be suppressed.

Next, the details of the configuration of a joint 80 according to the fourth embodiment will be described. As illustrated in FIGS. 8A and 8B, the joint 80 integrally has a coupling portion 81 coupled to a fluid discharge portion 25, a connection portion 82 to which the discharge pipe is connected, and a joint body 83 that connects the coupling portion 81 to the connection portion 82. Since the coupling portion 71, the connection portion 72 and the joint body 73 are all tubular (or hollow), the oil can flow through them.

As illustrated in FIG. 8B, a metal C-ring 81A and a rubber O-ring 81B are arranged inside the coupling portion 81. The coupling portion 81 has a ring-shaped first groove 81C on the inner peripheral surface, and the C-ring 81A is housed in the first groove 81C. Since the C-ring 81A is partially cut out, the diameter of the C-ring 81A can be increased. Further, the coupling portion 81 has a ring-shaped second groove, not illustrated in FIG. 8B, on the inner peripheral surface thereof, and the O-ring 81B is housed in the second groove. The second groove is located closer to the joint body 83 than the first groove 81C. In FIG. 8B, since the O-ring 81B is housed in the second groove, the second groove is not illustrated. The details of the second groove will be described later.

The details of the operation of the joint 80 according to the fourth embodiment will be described with reference to FIGS. 9A and 9B. First, when the joint 80 is separated from the operation valve 20 and is in the attachable state, as illustrated in FIG. 9A, the joint body 83 is moved toward the operation valve 20 as illustrated by a void arrow. The joint body 83 is pushed toward the operation valve 20 in a state where the joint body 83 is moved toward the operation valve 20 and an inner circumference of the C-ring 81A is in contact with an expansion portion 25B of the fluid discharge portion 25. Since an outer diameter of a groove bottom of the first groove 81C is larger than the outer diameter of the C-ring 81A at the time of its original shape as illustrated in FIG. 9A, while the C-ring 81A is getting over the expansion portion 25B, the diameter of the C-ring 81A temporarily expands toward the outside of the coupling portion 81 as the diameter expanding state.

When the C-ring 81A finishes getting over the expansion portion 25B, the C-ring 81A returns from the diameter expanding state to the original state before the diameter expanding state. Thereby, as illustrated in FIG. 9B, the C-ring 81A engages with the expansion portion 25B, and the tip of the coupling portion 81 comes into contact with a seat surface 25F of a pedestal portion 25D in the fluid discharge portion 25 or is separated from the seat surface 25F of the pedestal portion 25D. When the C-ring 81A engages with the expansion portion 25B, a fluid discharge port 25A and a fluid inflow port 81D of the coupling portion 81 (see FIG. 9A) come into contact with each other.

When the fluid discharge port 25A and the fluid inflow port 81D come into contact with each other, a fluid passage 25E provided inside the fluid discharge portion 25 and a joint passage 80A provided inside the joint 80 are coupled to each other. As a result, the joint 80 is in the detachable state in which the joint 80 can be detached from the operation valve 20. In this way, by employing the C-ring 81A that can expand its diameter while getting over the expansion portion 25B, the joint 80 can be easily attached to the operation valve 20 as compared with a case where the ring member whose diameter does not expand is employed.

When the joint 80 is in the detachable state and the joint body 83 is moved away from the operation valve 20, the joint 80 can be easily detached from the operation valve 20 in a reverse order of the above description. In particular, in the fourth embodiment, since the C-ring 81A and the expansion portion 25B are engaged with each other, the joint 80 is firmly coupled to the operation valve 20. However, if the joint body 83 is moved away from the operation valve 20 by a force that allows the C-ring 81A to get over the step of the expansion portion 25B, the joint 80 can be detached from the operation valve 20. Thus, the joint 80 according to the fourth embodiment can also ensure easy attachment to or detachment from the operation valve 20.

When the C-ring 81A engages with the expansion portion 25B, the O-ring 81B housed in a second groove 81F is located on the outer peripheral surface of the expansion portion 25B, as illustrated in FIG. 9B. Thereby, the sealability between the fluid discharge port 25A and the fluid inflow port 81D can be improved. Therefore, even if there is a gap between the fluid discharge port 25A and the fluid inflow port 81D, the gap is sealed by the O-ring 81B and oil leakage from the gap can be suppressed.

Although some embodiments of the present disclosure have been described in detail, the present disclosure is not limited to the specific embodiments but may be varied or changed within the scope of the present disclosure as claimed.

For example, in the first to fourth embodiments described above, the oil is described as an example of the fluid, but the fluid may be drinking water, or may be a flammable or nonflammable gas. The drinking water includes, for example, water, soft drinks, or alcoholic beverages. When the fluid is water, a faucet of the water supply including the expansion portion described in the first to fourth embodiments may be a coupling target of the joint. When the fluid is a gas, a gas cock including the expansion portion described in the first to fourth embodiments may be a coupling target of the joint 50, 60, 70 or 80.

Furthermore, if an environment in which the joint 50, 60 or 70 is used has a limitation on the number of parts, the first and second embodiments, which have a smaller number of parts than the third embodiment, may be employed. On the contrary, if there is no limit to the number of parts, any of the first or third embodiments may be employed. Further, when structural strength is required in the environment in which the joint 50, 60 or 70 is used, the engagement by the ring member 75, which is less likely to be damaged, is preferable to the engagement by the plurality of claws 64C, for example. On the contrary, if such a strength is not required, any of the first or third embodiments may be employed.

It should be considered that the above embodiments disclosed here are exemplary in all respects and not restrictive. The scope of the present invention is not limited to the specific embodiments of the disclosure. It is to be understood that the scope of the present invention is defined in the appended claims and includes equivalence of the description of the claims and all changes within the scope of the claims.

What is claimed is:

1. A joint that is coupled to a cylindrical fluid discharger whose peripheral edge expands radially outward, the joint comprising:
a cylindrical coupler that is coupled to the fluid discharger and has a male screw on an outer peripheral surface thereof;
an engager that engages with the peripheral edge; and
a tubular body that has a female screw to be coupled to the male screw on an inner peripheral surface thereof, and switches between a first state in which the attachment and the detachment of the fluid discharger and the joint are allowed and a second state in which the attachment and the detachment of the fluid discharger and the joint are restricted.

2. The joint according to claim 1, wherein
the engager has a plurality of claws extending toward the peripheral edge,
the plurality of claws are provided integrally with the coupler on a peripheral edge of the coupler in a state of being separated from each other by a gap, and
the tubular body allows the attachment and the detachment by allowing the diameter expansion of the plurality of claws, and restricts the attachment and the detachment by restricting the diameter expansion of the plurality of claws.

3. The joint according to claim 1, wherein
in an axial direction of the coupler, the male screw is longer than the female screw.

4. The joint according to claim 2, wherein
each of the plurality of claws includes a protrusion protruding toward a central axis of the coupler.

5. The joint according to claim 2, wherein
the tubular body restricts the diameter expansion of the plurality of claws when the tubular body is located at one end of the coupler to be coupled to the fluid discharger,
the tubular body allows the diameter expansion of the plurality of claws when the tubular body is located at the other end of the coupler opposite to the one end of the coupler.

6. The joint according to claim 1, wherein
the joint is made of a resin, and is a mechanical joint that is mechanically couplable to the fluid discharger.

7. The joint according to claim 1, wherein
the tubular body includes a plate portion that has a circular first opening at its center, and partially closes a second opening of the tubular body having a diameter larger than that of the first opening,
the engager is provided on a peripheral edge of the first opening,
the engager has a plurality of claws that are curved toward a central axis of the tubular body and are separated from each other by a gap, and
the tubular body allows the attachment and the detachment by retracting a coupling end located at a tip portion of the coupler from a recess located inside each of the plurality of claws, and restricts the attachment and the detachment by housing the coupling end in the recess.

8. The joint according to claim 7, wherein
each of the plurality of claws includes:
an outer peripheral portion that extends along the central axis of the tubular body from the peripheral edge of the first opening in the plate portion;
a curved portion that is connected to one end of the outer peripheral portion and curved from the outer peripheral portion toward the central axis of the tubular body; and
a tip portion that is connected to one end of the curved portion and formed substantially parallel to the outer peripheral portion; and
the recess is surrounded by the outer peripheral portion, the curved portion and the tip portion.

9. The joint according to claim 1, wherein
the engager is a cylindrical engager,
the joint includes a ring member, the ring member integrally having a cylindrical engager and a tapered portion, the cylindrical engager having two different outer diameters and being provided on an end of the tapered portion having a wider outer diameter among the two different outer diameters, the ring member having a cutout penetrating the cylindrical engager and the tapered portion,
the tubular body includes a plate portion that has a circular first opening at its center, and partially closes a second opening of the tubular body having a diameter larger than that of the first opening, and
the tubular body allows the attachment and the detachment by separating a tapered surface having a tapered shape provided inside a coupling end located at a tip portion of the coupling portion from an outer peripheral surface of the tapered portion, and restricts the attachment and the detachment by pressing the outer peripheral surface of the tapered portion toward a central axis of the ring member by the tapered surface.

10. The joint according to claim 9, wherein
a width of the cylindrical engager is substantially the same as a thickness of the plate portion in the peripheral edge of the first opening.

11. The joint according to claim 9, wherein
an inner diameter of the cylindrical engager is smaller than an inner diameter of the tapered portion.

12. The joint according to claim 9, wherein
a step is provided on an inner peripheral surface of the ring member.

13. A joint that is coupled to a cylindrical fluid discharger whose peripheral edge expands radially outward, the joint comprising:
a cylindrical coupler that is coupled to the fluid discharger and has a ring-shaped first groove on an inner peripheral surface thereof; and
a C-ring housed in the first groove and engaged with the peripheral edge.

14. The joint according to claim 13, wherein
an outer diameter of the first groove is larger than an outer diameter of an original shape of the C-ring.

15. The joint according to claim 13, further comprising:
a connector to which a discharge pipe is connected; and
a main body that connects the coupler to the connector;
wherein an inner peripheral surface of the coupler has a ring-shaped second groove located closer to the main body than the first groove,
an O-ring is housed in the second groove and engages with the peripheral edge.

16. The joint according to claim 15, wherein
the C-ring is made of a metal and the O-ring is made of a rubber.

17. The joint according to claim 13, wherein
the joint is made of a resin, and is a mechanical joint that is mechanically couplable to the fluid discharger.
